(19) United States
(12) Patent Application Publication
(10) Pub. No.: US 2010/0295318 A1
(43) Pub. Date: Nov. 25, 2010

(54) WIND-POWERED ELECTRICITY GENERATOR

(76) Inventor: Fu-Chang LIAO, Toufen Chen (TW)

Correspondence Address: PATENTTM.US, P. O. BOX 82788, PORTLAND, OR, 97282-0788, US

(21) Appl. No.: 12/779,665

(22) Filed: May 13, 2010

(30) Foreign Application Priority Data
May 19, 2009 (TW) 098116689
May 12, 2010 (TW) 099115088

(51) Int. Cl. F03D 9/00; F03D 11/00

(52) U.S. Cl. 290/55

(57) ABSTRACT

A wind-powered electricity generator has a supporting tube, a rotating device, a drive device, a mounting frame, a guiding board and two fan bodies. The rotating device is rotatably mounted on the supporting tube and has a mounting tube, a top cover and a transmitting shaft. The drive device is mounted in the supporting tube and is connected to the transmitting shaft. The mounting frame is securely mounted on the mounting tube and has a spindle, a gear wheel and a dynamo. The guiding board is connected to the mounting frame, faces the wind in used and has multiple spindle rings, multiple pivotal panels, multiple linking arms, a driving shaft and an expansion device. The fan bodies are rotatably mounted around the spindle in the guiding board and each fan body has a central axle, multiple connecting tubes, multiple blades, two annular frames, multiple cross bars and multiple pull bars.

### BACKGROUND OF THE INVENTION

1. Field of the Invention

The present invention relates to a wind-powered electricity generator, and more particularly to a wind-powered electricity generator that can generate power safely.

2. Description of Related Art

The conventional wind-powered electricity generators have multiple blades to rotate to generate power. However, the wind-power is not stable and is depended on the weather and the conventional wind-powered electricity generator can not generate power in a slight wind condition and the blades of the conventional wind-powered electricity generator may be broken in a stiff wind condition.

The wind-powered electricity generator in accordance with the present invention mitigates or obviates the aforementioned problems.

### SUMMARY OF THE INVENTION

The main objective of the present invention is to provide a wind-powered electricity generator that can generate power safely.

The wind-powered electricity generator in accordance with the present invention has a supporting tube, a rotating device, a drive device, a mounting frame, a guiding board and two fan bodies. The rotating device is rotatably mounted on the supporting tube and has a mounting tube, a top cover and a transmitting shaft. The drive device is mounted in the supporting tube and is connected to the transmitting shaft. The mounting frame is securely mounted on the mounting tube and has a spindle, a gear wheel and a dynamo. The guiding board is connected to the mounting frame, faces the wind in used and has multiple spindle rings, multiple pivotal panels, multiple linking arms, a driving shaft and an expansion device. The fan bodies are rotatably mounted around the spindle of the mounting frame in the guiding board and each fan body has a central axle, multiple connecting tubes, multiple blades, two annular frames, multiple cross bars and multiple pull bars.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a wind-powered electricity generator in accordance with the present invention;

FIG. 2 is an exploded perspective view of the wind-powered electricity generator in FIG. 1;

FIG. 3 is an operational perspective view of the wind-powered electricity generator in FIG. 1;

FIG. 4 is an enlarged and exploded perspective view of a first embodiment of a blade of the wind-powered electricity generator in FIG. 1;

FIG. 5 is an operational perspective view of the blade of the wind-powered electricity generator in FIG. 4;

FIG. 6 is an enlarged perspective view of a second embodiment of a blade of the wind-powered electricity generator in FIG. 1;

FIG. 7 is an operational perspective view of the blade of the wind-powered electricity generator in FIG. 6;

FIG. 8A is an enlarged perspective view of a guiding board of the wind-powered electricity generator in FIG. 1;

FIG. 8B is an enlarged perspective view of a pivotal panel of the guiding board in FIG. 8;

FIG. 9 is an enlarged perspective view of a fan body of the wind-powered electricity generator in FIG. 1;

FIG. 10 is an exploded view of a supporting tube of the wind-powered electricity generator in FIG. 1;

FIG. 11 is a side view in partial section of the supporting tube in FIG. 10;

FIG. 12 is a perspective view of a second embodiment of a wind-powered electricity generator in accordance with the present invention;

FIG. 13 is an exploded perspective view of the wind-powered electricity generator in FIG. 12;

FIG. 14 is an operational perspective view of the wind-powered electricity generator in FIG. 12; and

FIG. 15 is an enlarged and exploded perspective view of a moving device of the wind-powered electricity generator mounted on an annular rail in FIG. 12.

### DETAILED DESCRIPTION OF THE PREFERRED EMBODIMENT

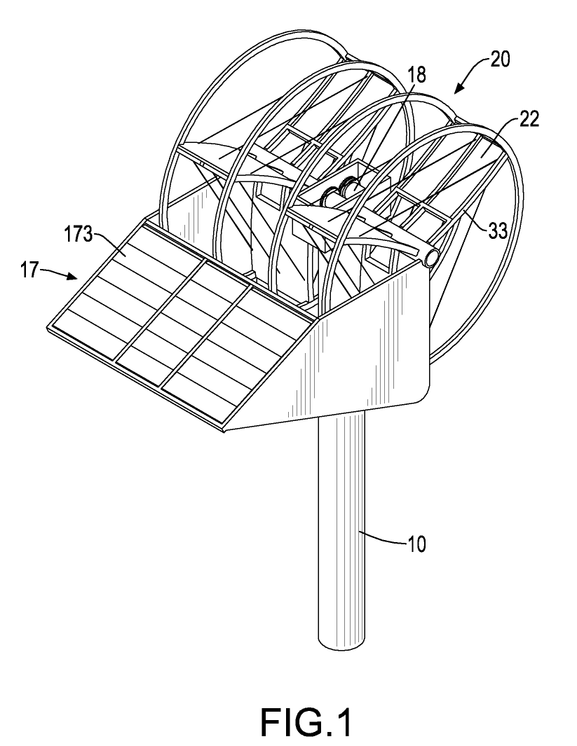

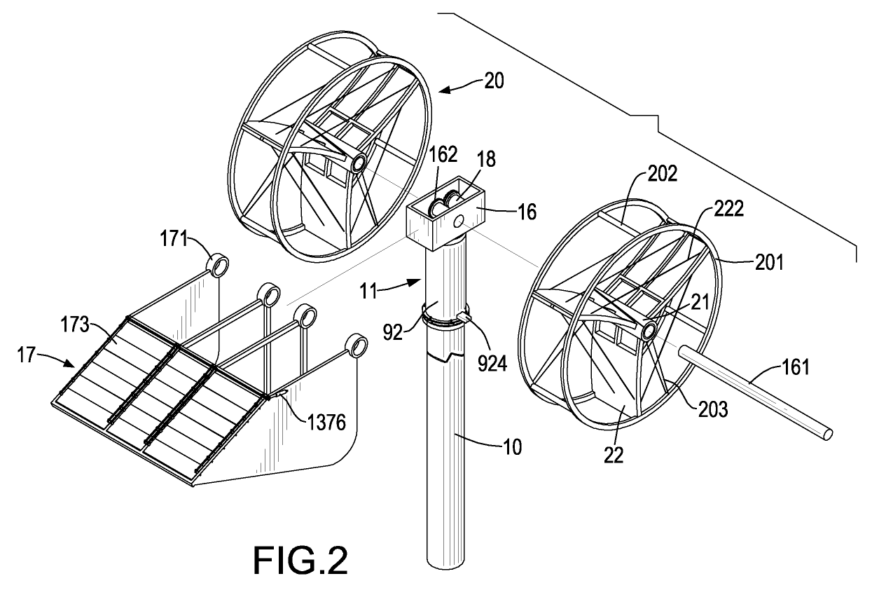

With reference to FIGS. 1 and 2, a first embodiment of a wind-powered electricity generator in accordance with the present invention comprises a supporting tube (10), a rotating device (11), a drive device (80), a mounting frame (16), a guiding board (17) and two fan bodies (20).

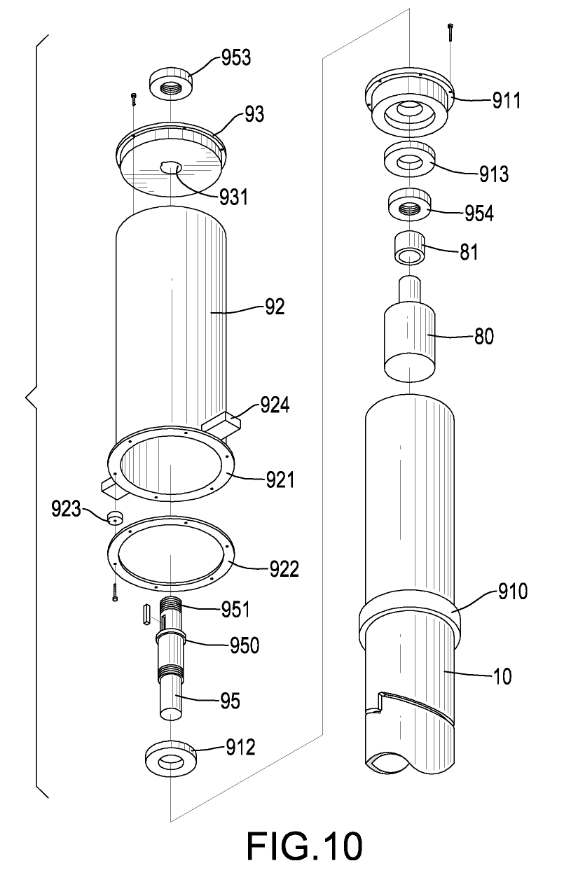

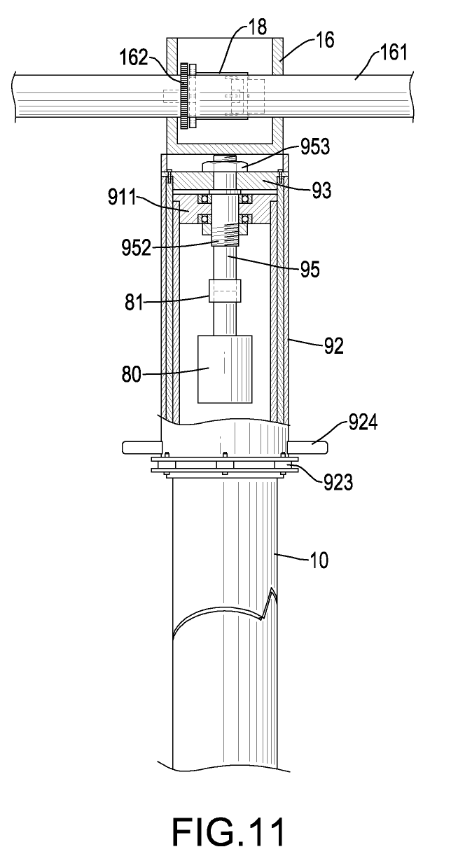

With reference to FIGS. 10 and 11, the supporting tube (10) is mounted on a fixture to provide a supporting effect, may be hollow and has an external surface, an open top end, a track (910) and a shaft mount (911). The track (910) is formed around the external surface of the supporting tube (10) near the open top end. The shaft mount (911) is securely mounted in the open top end of the supporting tube (10) by fasteners and has two bearings (912, 913).

The rotating device (11) is rotatably mounted on the supporting tube (10) and has a mounting tube (92), a top cover (93) and a transmitting shaft (95). The mounting tube (92) is hollow, is mounted around the supporting tube (10) and has a lower end, an upper end, an external surface, a protruding flange (921), a mounting ring (922), multiple rotating wheels (923) and two holding blocks (924). The lower end of the mounting tube (92) is mounted around the supporting tube (10) near the track (910). The protruding flange (921) is formed around and protrudes radially from the lower end of the mounting tube (92). The mounting ring (922) has a shape corresponding to the protruding flange (921) and is connected to the protruding flange (921) by fasteners. The rotating wheels (923) are rotatably mounted between the protruding flange (921) and the mounting ring (922) and abut the track (910) of the supporting tube (10). The holding blocks (924) are formed on and protrude radially from the external surface of the mounting tube (92) above the protruding flange (921).

The top cover (93) is securely mounted in the upper end of the mounting tube (92) by fasteners and has a center and a mounting hole (931). The mounting hole (931) is formed through the center of the top cover (93).

The transmitting shaft (95) is mounted through the shaft mount (911) and the top cover (93) and has an inner end, a middle, an outer end, an external surface, an upper thread (951), a lower thread (952), a holding ring (950), an upper nut (953) and a lower nut (954). The inner end of the transmitting shaft (95) is mounted in the supporting tube (10). The outer end of the transmitting shaft (95) is mounted through and extends out of the top cover (93) form the mounting hole (931). The upper thread (951) is formed on the external surface of the transmitting shaft (95) near the outer end. The lower thread (952) is formed on external surface of the transmitting shaft (95) near the middle. The holding ring (950) is formed around the external surface of the transmitting shaft (95) between the threads (951, 952). The upper nut (953) is screwed with the upper thread (951) to hold the transmitting shaft (95) with the top cover (93). The lower nut (954) is screwed with the lower thread (952) to hold the transmitting shaft (95) with the shaft mount (911). The bearings (912, 913) of the shaft mount (911) are mounted around the transmitting shaft (95) between the holding ring (950) and the lower thread (952).

The drive device (80) is mounted in the supporting tube (10), is connected to the inner end of the transmitting shaft (15) and has an output end and a clutch (81). The clutch (81) is mounted on the output end of the drive device (80), is connected to the inner end of the transmitting shaft (15) to transport power to the mounting tube (92) from the drive device (80).

The mounting frame (16) is securely mounted on the upper end of the mounting tube (92) of the rotating device (11) by fasteners and has a middle, a spindle (161), a gear wheel (162) and a dynamo (18). The spindle (161) is rotatably and transversally mounted in the middle of the mounting frame (16) and has two free ends extended out of the mounting frame (16). The gear wheel (162) is securely mounted around the spindle (161) in the mounting frame (16). The dynamo (18) is mounted in the mounting frame (16) and is connected to the gear wheel (162).

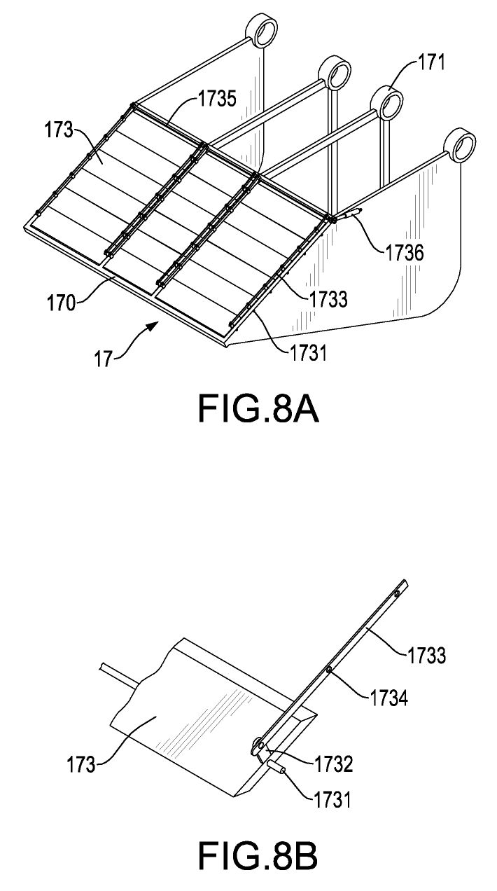

With reference to FIGS. 8A and 8B, the guiding board (17) is connected to the mounting frame (16), faces the wind in used and provides a concentration and guiding effect to the wind to the fan bodies (20), may be composed of multiple beams (170) and has a bottom, a front side, a rear side, a sidewall, multiple spindle rings (171), multiple pivotal panels (173), multiple linking arms (1733), a driving shaft (1735) and an expansion device (1736). The bottom of the guiding board (17) is securely connected to the holding blocks (924) of the mounting tube (92). The front side of the guiding board (17) faces the wind in used. The spindle rings (171) are formed on the rear side of the guiding board (17) at intervals and are mounted around the spindle (161) of the mounting frame (16). The pivotal panels (173) are mounted on the front side of the guiding board (17) and each pivotal panel (173) has two opposite sides, a mounting post (1731) and two connecting wings (1732). The mounting post (1731) is mounted in the pivotal panel (173), extends out of the opposite sides of the pivotal panel (173) and is connected to the beams (170) of the guiding board (17). The connecting wings (1732) are formed on and protrude from the pivotal panel (173) respectively at the opposite sides.

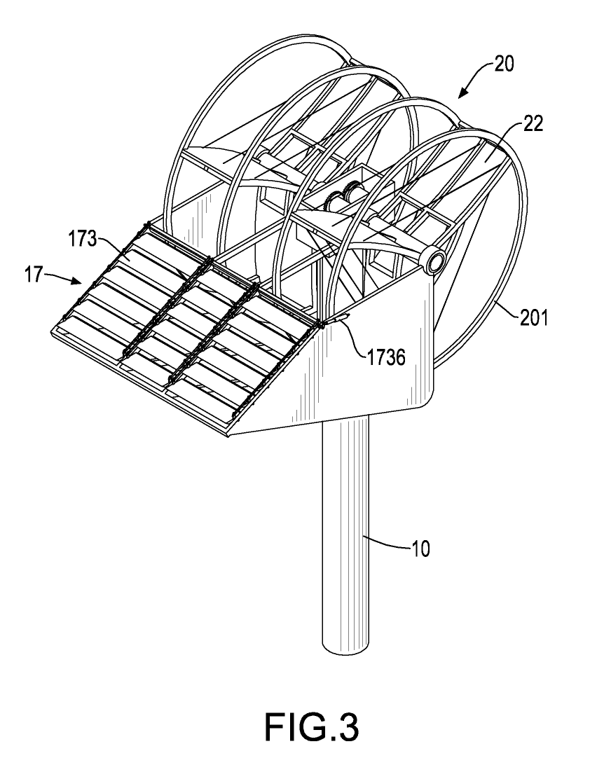

The linking arms (1733) are connected to the pivotal panels (173) and each linking arm (1733) has multiple connecting holes (1734). The connecting holes (1734) are formed through the linking arm (1733) at intervals and each connecting hole (1734) is connected to one of the connecting wings (1732) of a corresponding pivotal panel (173). The driving shaft (1735) is rotatably connected to the linking arms (1733) and has a free end extended to the sidewall of the guiding board (17). The expansion device (1736) is securely mounted on the sidewall of the guiding board (17) and is connected to the free end of the driving shaft (1735). With reference to FIGS. 1 and 3, when the driving shaft (1735) is rotated by the expansion device (1736), the pivotal panels (173) will rotate relative to the guiding board (17) to form a closed condition or an open condition.

With reference to FIGS. 2, 4, 5 and 6, the fan bodies (20) are mounted around the spindle (161) of the mounting frame (16) and are held in the guiding board (17), and each fan body (20) has a center, a central axle (21), multiple holding frames, two annular frames (201), multiple cross bars (202) and multiple pull bars (203). The central axle (21) is transversally defined in the center of the fan body (20) and has an external surface.

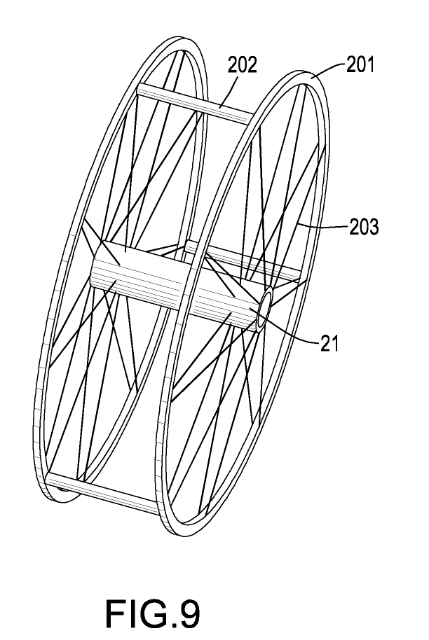

The holding frames are radially formed on the external surface of the central axle (21) at intervals, may be composed of multiple connecting tubes (33, 33a, 33b) and each holding frame has multiple bar holes (221) and multiple blades (22, 22a, 22b). The bar holes (221) are formed in the holding frame at positions opposite to the central axle (21). The blades (22, 22a, 22b) are mounted in the holding frame between the connecting tubes (33, 33a, 33b) and each blade (22) has two sidewalls and multiple holding bars (222). The holding bars (222) are connected to the bars holes (221) and each holding bar (222) may be cable wire, a circular steel bar or a flat steel bar. Preferably, three holding frames are mounted on the central axle (21) at intervals. With reference to FIG. 9, the annular frames (201) are respectively connected to the sidewalls of the blades (22). The cross bars (202) are connected to the annular frames (201) at intervals. The pull bars (203) are securely connected to the external surface of the central axle (21) and the annular frames (201). Preferably, each pull bar (203) may be a cable wire, a circular steel bar or a flat steel bar.

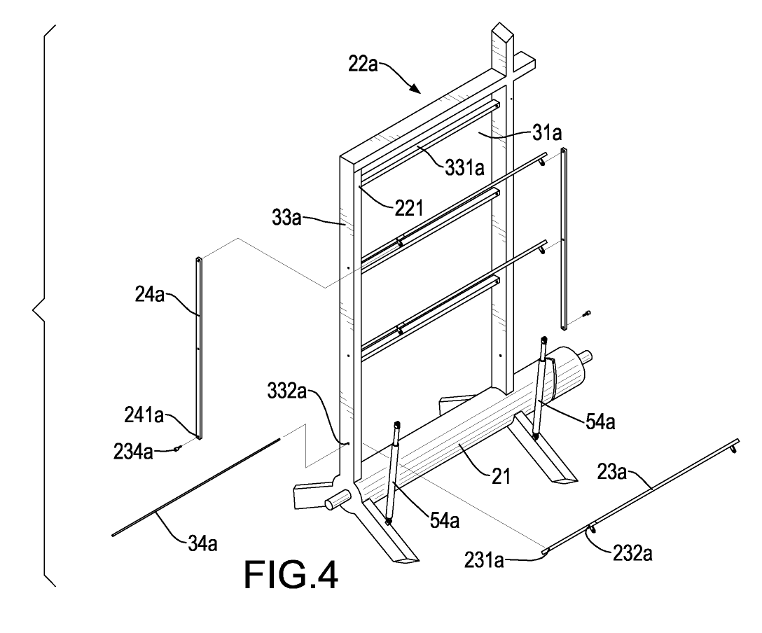

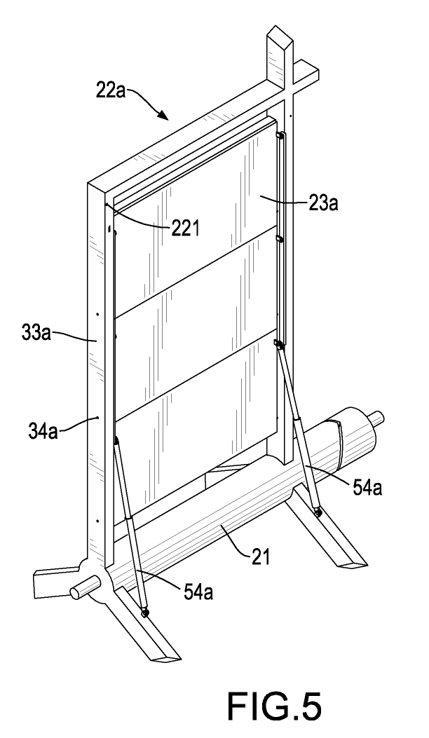

With reference to FIGS. 4 and 5, in a first embodiment of the blade (22a), at least one space (31a) defined between the connecting tubes (33a) of the holding frame and the blade (22a) has multiple post holes (332a), multiple movable boards (23a), multiple limiting arms (331a), two linking beams (24a) and two expansion devices (54a). The post holes (332a) are formed through the two opposite connecting tubes (33a) of the holding frame and align with each other.

The movable boards (23a) are movably mounted in the at least one space (31a) and each movable board (23a) has a sidewall, a connecting hole (231a), a connecting post (34a), a pin hole (232a), multiple linking wings and a pivotal pin (234a). The connecting hole (231a) is formed through the sidewall of the movable board (23a) and aligns with one of the post holes (332a). The connecting post (34a) is mounted in the connecting hole (231a) and a corresponding post hole (332a) to connect the movable board (23a) with the holding frame. The pin hole (232a) is formed through the sidewall of the movable board (23a). The linking wings are formed on the movable board (23a). The pivotal pin (234a) is mounted in the pin hole (232a) of the movable board (23a). Preferably, the blade (22a) has three movable boards (23a).

The limiting arms (331a) are transversally connected to the opposite connecting tubes (33a) of the holding frame. The linking beams (24a) are pivotally connected to the movable boards (23a) and each linking beam (24a) has multiple pin holes (241a). The pin holes (241a) are formed through the linking beam (24a), align with the pin holes (232a) of the movable boards (23a) and are connected to the pivotal pins (234a) of the movable boards (23a). The expansion devices (54a) are respectively mounted on two of the connecting tubes (33a) that adjacent to the central axle (21) and are respectively connected to the linking beams (24a) and the linking wings of one of the movable boards (23a). When the linking beams (24a) are pivoted by the expansion devices (54a), the movable boards (23a) will pivot relative to the central axle (21) to form a closed condition or an open condition.

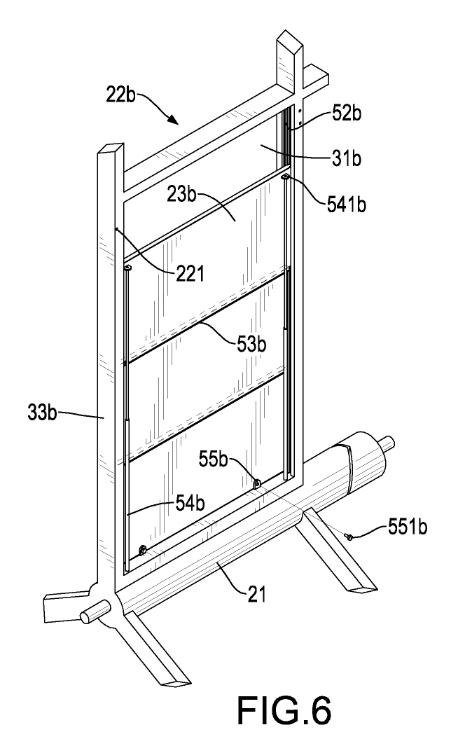

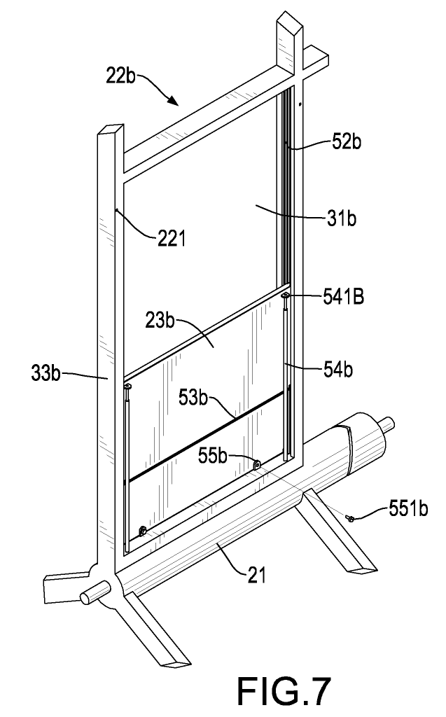

With reference to FIGS. 6 and 7, in a second embodiment of the blade (22b), at least one space (31b) defined between the connecting tubes (33b) of the holding frame and the blade (22b) has at least one guiding rail (52b), at least one movable board (23b) and two expansion devices (54b).

The at least guiding rail (52b) is mounted on one of the opposite connecting tubes (33b) of the holding frame. The at least one movable board (23b) is movably mounted in the at least one space (31b), is connected to the at least guiding rail (52b) and each movable board (23b) has a top side, a bottom side and two guiding flanges (53b). The guiding flanges (53b) are respectively formed on the top side and the bottom side of the movable board (23b). Preferably, the blade (22b) has three guiding rails (52b) parallel with each other and three movable boards (23b) are respectively connected to the guiding rails (52b). One of the movable boards (23b) has multiple connecting wings (55b) and multiple fasteners (551b). The connecting wings (55b) of the movable board (23b) are mounted on one of the connecting tubes (33b) of the holding frame. The fasteners (551b) are mounted through the connecting wings (55b) and are connected to the movable board (23b).

The expansion devices (54b) are securely mounted on the connecting tube (33b) on which the connecting wings (55b) are mounted at intervals and are connected to one of the movable boards (23b). Each expansion device (54b) has the same direction as that of the at least one guiding rail (52b), a free end and a connecting element (541b). The connecting elements (541b) are respectively mounted on the free ends of the expansion devices (54b) and are connected to the corresponding movable board (23b). When the expansion devices (54b) push or pull the corresponding movable board (23b) that the connecting elements (541b) connected, the movable boards (23a) will move upward or downward relative to the central axle (21) to form a closed condition or an open condition.

With reference to FIGS. 1 and 2, in use, the supporting tube (10) is securely mounted on a fixture, the mounting tube (92), the top cover (93) and the transmitting shaft (95) of the rotating device (11) are mounted on the open top end of the supporting tube (10) and the mounting frame (16) is securely mounted on the mounting tube (92). The dynamo (18) is mounted in the mounting frame (16) to connect with the gear wheel (162). In addition, one of the embodiments of the blade (22a, 22b) of the fan body (20) is chosen to form as the generator in accordance with the present invention. After mounting the fan bodies (20) on the mounting frame (16), the guiding board (17) is mounted on the spindle (161) of the mounting frame (16) and is securely connected to the holding blocks (924) of the mounting tube (92).

In use, with further reference to FIG. 1, when the first embodiment of the wind-powered electricity generator in accordance with the present invention is used in a slight wind condition, the mounting frame (16) is rotated by the drive device (80) to allow the fan bodies (20) facing the wind and the pivotal panels (173) are pivoted relative to the guiding board (17) to form a closed condition by the expansion device (1736) rotating the driving shaft (1735).

With reference to FIGS. 4 and 5, in the first embodiment of the blade (22a), the expansion devices (54a) drive the linking beams (24a) to move the movable boards (23a) synchronously upward by the linking beams (24a) to form a closed condition as shown in FIG. 5. With reference to FIG. 7, in the second embodiment of the blade (22b), the expansion devices (54b) drive the movable boards (23b) to move synchronously upward along the guiding rails (52b) by the guiding flanges (53b) to form a closed condition.

By the above-mentioned operation, the guiding board (17) is rotated to face the wind and the movable panels (173) of the guiding board (17) and the blades (22a, 22b) of the fan bodies (20) are driven to form a closed condition. The closed guiding board (17) can provide a guiding effect to the wind and to make the wind flowing into the fan bodies (20) in concentration to rotate the spindle (161) with the fan bodies (20). Then, the dynamo (18) that is mounted in the mounting frame (16) can generate power with the connection with the gear wheel (162) of the mounting frame (16) in the slight wind condition.

In addition, when the first embodiment of the wind-powered electricity generator in accordance with the present invention is used in a stiff wind condition, with reference to FIGS. 3 and 8B, the pivotal panels (173) are rotated to form an open condition to decrease the wind drag force. Furthermore, the blades (22a, 22b) are also adjusted to an open condition to decrease the moment of the wind applied to the fan bodies (20).

With reference to FIG. 4, when using the first embodiment of the blade (22a), the expansion devices (54a) drive the movable boards (23a) synchronously and aslant pivoting with the transmission of the linking beams (24a) to form an open condition. With reference to FIG. 7, when using the second embodiment of the blade (22b), the expansion devices (54b) drive the movable boards (23b) synchronously moving downward along the guiding rails (52b) by the guiding flanges (53b) to form an open condition. Then, the open conditions of the blades (22a, 22b) can allow the wind flowing through the wind-powered electricity generator and this can decrease the wind drag force applied onto the blades (22a, 22b) and can prevent the wind-powered electricity generator from breaking in a stiff wind condition.

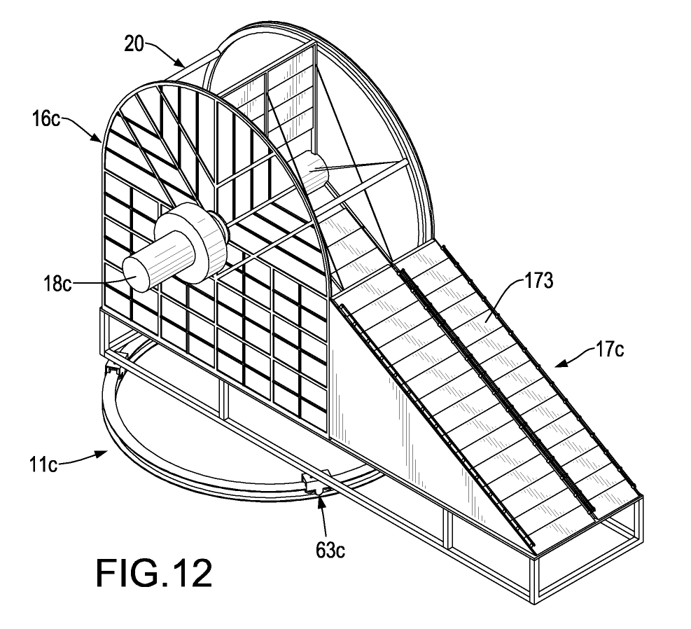

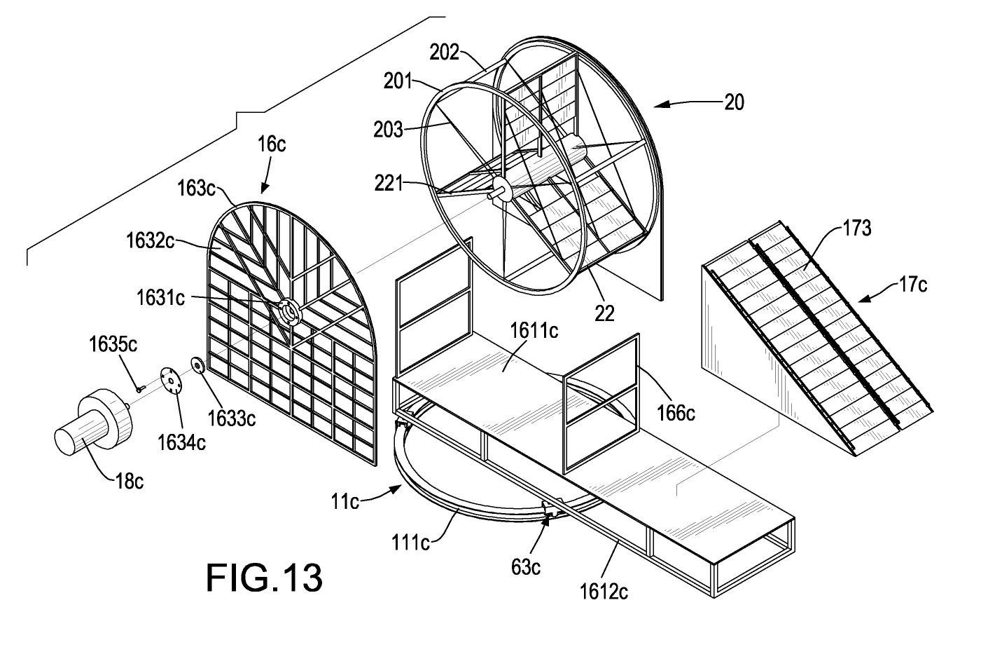

With reference to FIGS. 12 and 13, the second embodiment of a wind-powered electricity generator in accordance with the present invention comprises a rotating device (11c), a bottom seat (1611c), a mounting frame (16c), a fan body (20) and a guiding board (17c).

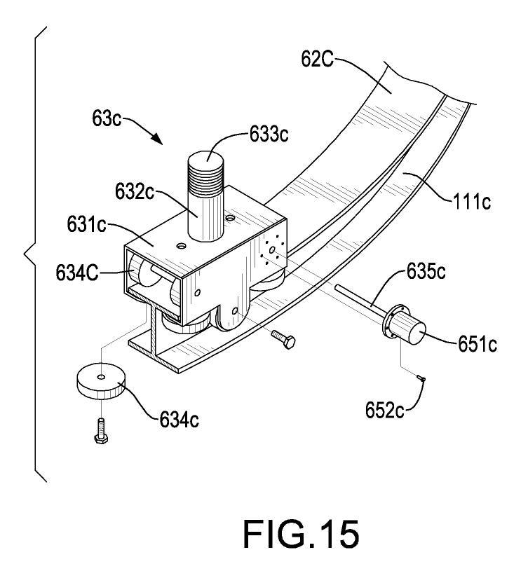

With reference to FIG. 15, the rotating device (11c) may be a rotating device that is mounted on a crane or a rooter and has an annular rail (111c), multiple moving devices (63c) and a drive device (651c). The annular rail (111c) may be an H-shaped or I-shaped section steel (62c) and has a bottom, an upper rail panel and a lower rail panel. Preferably, the bottom of the annular rail (111c) is securely mounted on a building, a shaft or a mount.

Each moving device (63c) is slidably mounted on the annular rail (111c) and has a connecting frame (631c), a screw (632c) and multiple rotating wheels (634c). The connecting frame (631c) is mounted around the upper rail panel of the annular rail (111c) and has a top. The screw (632c) is formed on and protrudes from the top of the connecting frame (631c) and has a top end and a thread (633c). The thread (633c) is formed around the top end of the screw (632c). The rotating wheels (634c) are rotatably mounted in the connecting frame (631c) by wheel axles (635c) and abut the annular rail (111c).

The drive device (651c) is mounted on one of the connecting frames (631c) by multiple bolts (652c) and is connected to one of the wheel axles (635c) of the connecting frame (631c). Then, the moving device (63c) can be moved along the annular rail (111c) by the drive device (651c).

The bottom seat (1611c) is rotatably connected to the rotating device (11c) and has a bottom, a top and multiple reinforcing beams (1612c). The reinforcing beams (1612c) are connected to each other to form the bottom of the bottom seat (1161c) and are connected to the screws (632c) of the moving devices (63c). Then, the bottom seat (1611c) can be moved relative to the annular rail (111c). The top of the bottom seat (1611c) is a board and is mounted on the reinforcing beams (1612c).

The mounting frame (16c) is securely mounted on the bottom seat (1611c) and has two side covering panels (163c), two connecting panels (166c), two bearings (1633c), two bearing covers (1634c) and multiple bolts (1635c). The side covering panels (163c) are mounted on the top of the bottom seat (1611c), face each other and each side covering panel (163c) may be composed of multiple tubes and has a top, an outer side, a bearing mount (1631c) and a mounting board (1632c). The top of the side covering panel (163c) is semicircular and has a center. The bearing mount (1631c) is formed in the center of the top of the side covering panel (163c). The mounting board (1632c) is mounted on the outer side of the side covering panel (163c). The covering panels (166c) are mounted on the top of the bottom seat (1611c) and are connected to the side covering panels (163c) to form a rectangular space. The bearings (1633c) are respectively mounted in the bearing mounts (1631c). The bearing covers (1634c) are respectively mounted on the outer sides of the side covering panels (163c) to cover the bearings (1633c). The bolts (1635c) are mounted through the bearing covers (1634c) and are connected to the bearing mounts (1631c) to hold the bearings (1633c) in the bearing mounts (1631c).

The fan body (20) is rotatably connected to the mounting frame (16c) in the rectangular space and has a similar structure as the fan body (20) in the first embodiment of the wind-powered electricity generator in accordance with the present invention. With further reference to FIGS. 2 and 9, the central axle (21) is pivotally mounted between the bearings (1633c) of the side covering panels (163c) and has two free ends extended out of the side covering panels (163c). Two dynamos (18c) are respectively connected to the free ends of the central axle (21) by clutches and are respectively mounted on the outer sides of the side covering panels (163c) to transform the mechanical energy of the fan body (20) into the electric energy by the dynamos (18c). In addition, the blades of the fan body (20) of the second embodiment of the wind-powered electricity generator in accordance with the present invention also has two kinds of blades (22a, 22b) as shown in FIGS. 4, 5, 6 and 7.

The guiding board (17c) is securely mounted on the top of the mounting frame (16c), abuts one of the connecting panels (166c) and has a similar structure as the guiding board (17) in the first embodiment of the wind-powered electricity generator in accordance with the present invention as shown in FIGS. 8A and 8B.

In used, with further reference to FIG. 12, when the second embodiment of the wind-powered electricity generator in accordance with the present invention is used in a slight wind condition, the mounting frame (16c) can be rotated relative to the annular rail (111c) by the drive devices (651c) driving the moving devices (63c) to make the fan body (20) facing the wind. The pivotal panels (173) are rotated relative to the guiding board (17c) to form a closed condition by the expansion device (1736) rotating the driving shaft (1735). In addition, the movable boards (23a, 23b) of the blades (22a, 22b) also can be adjusted to form closed conditions as shown in FIGS. 4 to 7. Then, the wind can be guided to flow into the fan body (20) by the guiding board (17c) to rotate the central axle (21) with the fan body (20). Thus, the dynamos (18c) that are mounted on the free ends of the central axle (21) can generate power in a slight wind condition.

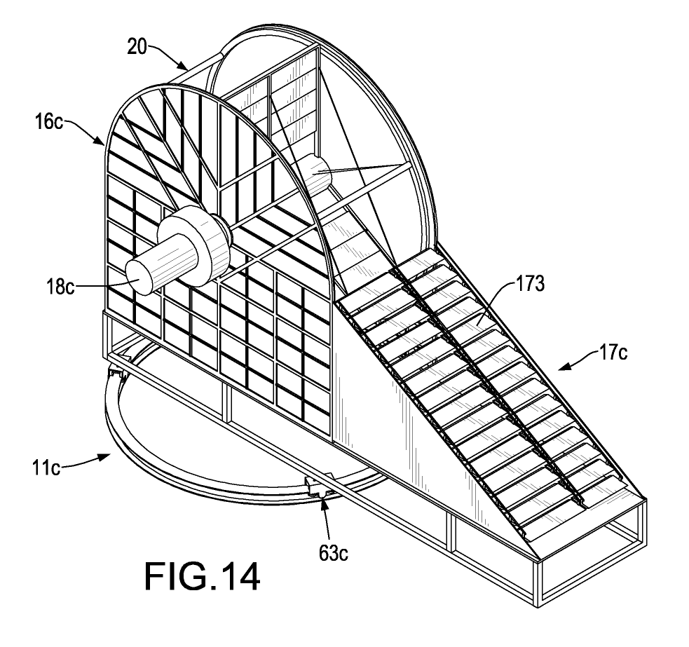

When the second embodiment of the wind-powered electricity generator in accordance with the present invention is used in a stiff wind condition, with reference to FIG. 14, the pivotal panels (173) are rotated form an open condition to decrease the wind drag force. Furthermore, the blades (22a, 22b) can be adjusted to an open condition to decrease the moment of wind applied onto the fan body (20) as shown in FIGS. 4 to 7.

The wind-powered electricity generator as described has the following advantages.

1. The pivotal panels (173) of the guiding board (17, 17c) and the movable boards (23a, 23b) of the blades (22, 22a, 22b) of the fan body (20) can be operated in a closed condition in the slight wind condition and this can increase the efficiency of the wind-powered electricity generator.

2. The pivotal panels (173) of the guiding board (17, 17c) and the movable boards (23a, 23b) of the blades (22, 22a, 22b) of the fan body (20) can be operated in an open close condition in the stiff wind condition. Then, the wind can flow through the wind-powered electricity generator and this can decrease the wind drag force applied on the blades (22a, 22b) and can prevent the blades (22, 22a, 22b) from being broken. Then, the use of the wind-powered electricity generator in accordance with the present invention is safe.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wind-powered electricity generator having
a supporting tube adapted to mount on a fixture and having a supporting capability and a top end;
a rotating device rotatably mounted on the top end of the supporting tube and having a rotating capability relative to the supporting tube;
a mounting frame securely mounted on the rotating device and having
a spindle rotatably and transversally mounted in the mounting frame; and
a dynamo mounted in the mounting frame and connected to the spindle;
two fan bodies mounted around the spindle of the mounting frame and each fan body having
a center;
a central axle transversally defined in the center of the fan body; and
multiple blades mounted on the central axle; and
a guiding board connected to the mounting frame beside the fan bodies to provide a concentration and guiding effect to the wind to rotate the fan bodies by the wind power and transform mechanical energy of the fan bodies into electricity power with the dynamo.

2. The wind-powered electricity generator as claimed in claim 1, wherein
each central axle has an external surface;
each fan body has
multiple holding frames radially formed on the external surface of the central axle at intervals, being composed of multiple connecting tubes and each holding frame having
at least one space defined between the connecting tubes of the holding frame; and
the blades are mounted respectively in the holding frames between the connecting tubes and each blade has at least one movable board movable mounted in the at least one space of a corresponding holding frame.

3. The wind-powered electricity generator as claimed in claim 2, wherein
each one of the at least one movable board is pivotally connected to one of the connecting tube by a pivotal pin; and
each blade has
two linking beams pivotally connected to the at least one movable board; and
two expansion devices respectively mounted on two of the connecting tubes that adjacent to the central axle and respectively connected to the linking beams and one of the movable boards.

4. The wind-powered electricity generator as claimed in claim 2, wherein
each blade has
at least one guiding rail mounted on one of the connecting tubes of a corresponding holding frame; and
two expansion devices securely mounted on the corresponding holding frame and connected to the at least one movable board of the blade; and
each one of the at least one movable board of each blade is movably mounted in the at least one space of the corresponding holding frame and is connected to the at least guiding rail of the blade.

5. The wind-powered electricity generator as claimed in claim 2, wherein
each holding frame has multiple bar holes formed in the holding frame at positions opposite to the central axle; and
each blade has multiple holding bars connected to the bars holes of a corresponding holding frame.

6. The wind-powered electricity generator as claimed in claim 5, wherein
each blade has two sidewalls; and
each fan body has
two annular frames respectively connected to the sidewalls of the blades of the fan body; and
multiple cross bars connected to the annular frames at intervals.

7. The wind-powered electricity generator as claimed in claim 6, wherein each fan body has multiple pull bars securely connected to the external surface of the central axle and the annular frames of the fan body.

8. The wind-powered electricity generator as claimed in claim 7, wherein
the supporting tube is hollow and has
an external surface;
an open top end;
a track formed on the external surface of the supporting tube near the open top end; and
a shaft mount securely mounted in the open top end of the supporting tube;
the rotating device has
a mounting tube being hollow, mounted around the supporting tube and having
a lower end mounted around the supporting tube near the track;
an upper end; and
multiple rotating wheels rotatably connected to the lower end of the mounting tube and abutting the track of the supporting tube;
a top cover securely mounted in the upper end of the mounting tube and having
a center; and
a mounting hole formed through the center of the top cover; and
a transmitting shaft connected to the shaft mount and the top cover and having
an inner end mounted in the supporting tube; and
an outer end extending out of the top cover form the mounting hole; and
the wind-powered electricity generator has a drive device mounted in the supporting tube and connected to the inner end of the transmitting shaft.

9. The wind-powered electricity generator as claimed in claim 8, wherein
the transmitting shaft has
a middle;
an external surface;
an upper thread formed on the external surface of the transmitting shaft near the outer end;
a lower thread formed on external surface of the transmitting shaft near the middle;
a holding ring formed around the external surface of the transmitting shaft between the threads;
an upper nut screwed with the upper thread to hold the transmitting shaft with the top cover; and
a lower nut screwed with the lower thread to hold the transmitting shaft with the shaft mount; and
the shaft mount has two bearings mounted around the transmitting shaft between the holding ring and the lower thread.

10. The wind-powered electricity generator as claimed in claim 9, wherein
the spindle has two free ends extended out of the mounting frame; and
the mounting frame has a gear wheel securely mounted around the spindle in the mounting frame and connected to the dynamo.

11. A wind-powered electricity generator having
a rotating device adapted to mount on a fixture and having a rotating capability;
a bottom seat rotatably mounted on a top of the rotating device;
a mounting frame securely mounted on the bottom seat and having
two side covering panels mounted a the top of the bottom seat, facing each other and each side covering panel having
a top being semicircular and having a center; and
a bearing mount formed in the center of the top of the side covering panel; and
two connecting panels mounted on the top of the bottom seat and connected to the side covering panels to form a rectangular space;
a fan body rotatably connected to the mounting frame in the rectangular space and having
a center;
a central axle transversally defined in the center of the fan body, pivotally mounted between the bearing mounts of the side covering panels and having two free ends extended out of the side covering panels; and
two dynamos respectively connected to the free ends of the central axle and respectively mounted on the side covering panels to transform the mechanical energy of the fan body into the electric energy by the dynamos; and
a guiding board securely mounted on a top of the mounting frame, to provide a concentration and guiding effect to the wind to rotate the fan body by the wind power and abutting one of the connecting panels.

12. The wind-powered electricity generator as claimed in claim 11, wherein
the central axle has an external surface;
the fan body has
multiple holding frames radially formed on the external surface of the central axle at intervals, being composed of multiple connecting tubes and each holding frame having
at least one space defined between the connecting tubes of the holding frame; and
the blades are mounted respectively in the holding frames between the connecting tubes and each blade has at least one movable board movable mounted in the at least one space of a corresponding holding frame.

13. The wind-powered electricity generator as claimed in claim 12, wherein
each one of the at least one movable board is pivotally connected to one of the connecting tube by a pivotal pin; and
each blade has
two linking beams pivotally connected to the at least one movable board; and
two expansion devices mounted on the external surface of the central axle and respectively connected to the linking beams.

14. The wind-powered electricity generator as claimed in claim 12, wherein
each blade has
at least one guiding rail mounted on one of the connecting tubes of a corresponding holding frame; and
two expansion devices securely mounted on the corresponding holding frame and connected to the at least one movable board of the blade; and
each one of the at least one movable board of each blade is movably mounted in the at least one space of the corresponding holding frame and is connected to the at least guiding rail of the blade.

15. The wind-powered electricity generator as claimed in claim 12, wherein
each holding frame has multiple bar holes formed in the holding frame at positions opposite to the central axle; and
each blade has multiple holding bars connected to the bars holes of a corresponding holding frame.

16. The wind-powered electricity generator as claimed in claim 15, wherein
each blade has two sidewalls; and
each fan body has
two annular frames respectively connected to the sidewalls of the blades of the fan body; and
multiple cross bars connected to the annular frames at intervals.

17. The wind-powered electricity generator as claimed in claim 16, wherein each fan body has multiple pull bars securely connected to the external surface of the central axle and the annular frames of the fan body.

18. The wind-powered electricity generator as claimed in claim 17, wherein the rotating device has
an annular rail having a bottom, an upper rail panel and a lower rail panel;
multiple moving devices slidably mounted on the annular rail; and
a drive device connected to one of the moving devices to provide power to the moving device to move along the annular rail.

19. The wind-powered electricity generator as claimed in claim 18, wherein
each moving device has
a connecting frame mounted around the upper rail panel of the annular rail and having a top
a screw formed on and protruding from the top of the connecting frame and having
a top end; and
a thread formed around the top end of the screw and connected to the bottom seat; and
multiple rotating wheels rotatably mounted in the connecting frame by wheel axles and abutting the annular rail; and
the drive device is mounted on one of the connecting frames and is connected to one of the wheel axles of the connecting frame.

20. The wind-powered electricity generator as claimed in claim 19, wherein the bottom seat has
a bottom;
multiple reinforcing beams connected to each other to form the bottom of the bottom seat and connected to the screws of the moving devices; and
a top being a board and mounted on the reinforcing beams.

21. The wind-powered electricity generator as claimed in claim 20, wherein the mounting frame has
two bearings respectively mounted in the bearing mounts;
two bearing covers respectively mounted on the outer sides of the side covering panels to cover the bearings; and
multiple bolts mounted through the bearing covers and connected to the bearing mounts to hold the bearings in the bearing mounts.
